(19) United States
(12) Patent Application Publication
(10) Pub. No.: US 2024/0132689 A1
(43) Pub. Date: Apr. 25, 2024

(54) SCALABLE, FIRE-RESISTANT, AND SPECTRALLY ROBUST MELAMINE-FORMALDEHYDE PHOTONIC BULK FOR EFFICIENT DAYTIME RADIATIVE COOLING

(71) Applicant: Northeastern University, Boston, MA (US)

(72) Inventors: Yi Zheng, Canton, MA (US); Yanpei Tian, Boston, MA (US); Xiaojie Liu, Boston, MA (US)

(21) Appl. No.: 18/276,721

(22) PCT Filed: Jan. 31, 2022
(86) PCT No.: PCT/US22/14487

§ 371 Date: Aug. 9, 2023

Related U.S. Application Data
(60) Provisional application No. 63/148,319, filed on Feb. 11, 2021.

(51) Int. Cl. C08J 9/24; C09K 5/14; C09K 21/14

(52) U.S. Cl. CPC C08J 9/24; C09K 5/14; C09K 21/14; C08J 2205/044; C08J 2207/00; C08J 2361/28

(57) ABSTRACT

Melamine Formaldehyde (MF) photonic cooling bulk is disclosed for covering outer surfaces of a building. The MF photonic cooling bulk comprises a mass of hydraulically pressed MF microparticles that has been thermally annealed to form a fire and corrosion-resistant, cross-linked photonic cooling bulk configured to reflect incident solar irradiation and radiate heat from the building to the outer space.

### CROSS REFERENCE TO RELATED APPLICATIONS

This application claims priority from U.S. Provisional Patent Application No. 63/148,319 filed on Feb. 11, 2021 entitled Fire-Retardant And Spectrally Robust Melamine Formaldehyde Photonic Bulk For Efficient Daytime Radiative Cooling, which is hereby incorporated by reference.

### STATEMENT AS TO FEDERALLY SPONSORED RESEARCH

This invention was made with government support under Grant No. CBET-1941743 awarded by the National Science Foundation. The government has certain rights in the invention.

### BACKGROUND

The present application relates generally to scalable, fire-resistant, and spectrally robust melamine-formaldehyde (MF) photonic bulk for efficient daytime radiative cooling.

Traditional building materials such as wood and concrete cannot effectively regulate the heat flux of buildings. Compressor-based cooling systems are used to provide comfortable interior environments for humans, contributing significantly to global energy consumption. It has recently been demonstrated that sub-ambient passive daytime radiative cooling can been obtained by efficiently radiating thermal energy to the cold outer space through the atmospheric transparent window while reflecting most of the solar irradiance.

In accordance with various embodiments, a high-performance daytime radiative cooling material is disclosed. The material is processed by hydraulic pressing MF particles and thermally annealing them into a cross-linked photonic cooling bulk as an efficient solar reflector and infrared thermal emitter. It reaches a sub-ambient stagnation temperature of 3.6° C. under direct sun irradiance (750 W m⁻²), which is 12° C. and 5° C. below the concrete and the wood as control group temperatures, respectively. The two-step fabrication process can be scaled up for industrial manufacturing. The as-prepared MF cooling material has highly desirable fire-resistant properties and is self-extinguishing, making it an excellent material for building safety. The material is durable and spectrally robust in harsh environments such as long exposure to the acidic and alkaline solutions.

### BRIEF SUMMARY OF THE DISCLOSURE

In accordance with one or more embodiments, MF photonic cooling bulk is disclosed for covering outer surfaces of a building. The MF photonic cooling bulk comprises a mass of hydraulically pressed MF microparticles that has been thermally annealed to form a fire and corrosion-resistant, cross-linked photonic cooling bulk configured to reflect incident solar irradiation and radiate heat from the building to the outer space.

In accordance with one or more embodiments, a method is disclosed, comprising the steps of: (a) hydraulically pressing MF microparticles; and (b) thermally annealing the pressed MF microparticles to form a fire-resistant, corrosion-resistant, cross-linked MF photonic cooling bulk configured for covering outer surfaces of a building to reflect incident solar irradiation on the building and radiate heat from the building to the outer space.

### BRIEF DESCRIPTION OF THE DRAWINGS

FIG. 1A is a schematic diagram showing the passive radiative cooling mechanism of MF cooling bulk in accordance with one or more embodiments, which has both high solar reflectance and infrared thermal emittance. The high solar reflectance reduces the heating effect from the solar irradiance and the high infrared thermal emittance enables the efficient radiation of heat to the cold outer space through the transparent atmospheric window.

FIG. 1B is a graph showing the spectral reflectance of two ideal scenarios: scenario 1 (line 2) with unity thermal emittance beyond 8.0 μm and scenario 2 (line 1) with unity thermal emittance just over the main atmospheric transparent window. Both scenarios have a unity solar reflectance over the solar wavelengths.

FIG. 1C shows an exemplary fabrication process of the MF cooling bulk in accordance with one or more embodiments. The process includes cold hydraulic pressing of MF powders and thermal annealing at 170° C. for 1 h. It can be easily integrated into scalable manufacturing.

FIG. 1D schematically shows the mechanism of high solar reflectance and thermal emittance of the MF cooling bulk in accordance with one or more embodiments. The sunlight scattering arises from the microparticles on the diffused surface of MF cooling bulk. The thermal emission is derived from the molecular vibrations of the chemical groups in the MF.

FIG. 1E is a graph showing spectral reflectance (R=1−ε when objects are opaque) of the MF cooling bulk exhibited against the AM 1.5 solar spectrum (ASTM G173), the 30° C. blackbody thermal radiative spectrum, and the downwelling heat of the 30° C. blackbody due to the atmospheric transparent window.

FIG. 1F is a graph showing the overall solar reflectance 3 and thermal emittance 4 of the MF cooling bulk across various angles of incidence (AOI) indicating angle-independent hemispherical solar reflectance and thermal emittance.

FIG. 2A is a top view and FIG. 2B is a cross section view of the fabricated MF cooling bulk with dimensions of 5 cm×4 cm×0.5 cm.

FIGS. 2C, 2E, 2G, AND 2I are scanning electron microscope (SEM) images of the original MF particles (FIG. 2C), cold hydraulic pressed MF (FIG. 2E), and the top view (FIG. 2G) and the cross-section view (FIG. 2I) of the annealed MF cooling bulk.

FIGS. 2D, 2F, 2H, and 2J are graphs showing size distributions of the original MF particles (FIG. 2D), cold hydraulic pressed MF (FIG. 2F), and the top view (FIG. 2H) and the cross-section view (FIG. 2J) of the annealed MF cooling bulk.

FIG. 2K is a graph showing differential scanning calorimetry (DSC) thermograms of MF particles at a heating rate of 10° C./min. Circles 5 and 6 indicate two steps of the MF cross-link reaction.

FIG. 2L is a graph showing Thermogravimetric analysis (TGA) thermograms for the original MF particles and the 170° C. annealed MF cooling bulk. The inset is the TGA thermograms of MF particles from 50° C. to 200° C. Circles 7 and 8 show the two steps of the decomposition of MF bulk.

FIG. 3A shows a light scattering experimental setup.

FIG. 3B discloses photos showing the light scattering phenomena when the MF particles are irradiated by a green laser.

FIG. 3C is a wireframe diagram showing the molecular structure of the MF.

FIG. 3D is a graph showing the FTIR transmittance spectra of the original MF particles 7 and the annealed MF 8 displaying bands in the atmospheric transparent window resulting in the high thermal emittance.

FIG. 4A is a photograph showing an outdoor experimental setup for testing sub-ambient cooling performance under direct sunlight.

FIG. 4B is a photograph showing the experimental setup under a clear sky.

FIG. 4C is a schematic diagram of the outdoor experimental setup including the sample, thermal insulating aerogel, and PVC foam located inside a cooler box.

FIG. 4D is a graph showing the spectral reflectance of the MF cooling bulk 11, the wood 10, and the concrete 9.

FIG. 4E is a graphs showing temperature variations of the MF cooling bulk 11, the wood 10, the concrete 9, and the ambient.

FIG. 4F is a graph showing the temperature difference between the ambient and the MF cooling bulk 11, the wood 10, and the concrete 9.

FIG. 4G is an infrared thermal camera image showing the temperature difference between the MF cooling bulk, the wood, and the concrete.

FIG. 5A is a set of photographs showing the evaluation of the fire-resistant properties of the MF cooling bulk showing its excellent self-extinguishing functionality, while the wood and polystyrene (PS) foam, two common building materials, are easily burned out.

FIGS. 5B-5C are graphs showing the overall solar reflectance (FIG. 5B) and thermal emittance (FIG. 5C) of the MF cooling bulk in various harsh environments, such as being immersed into different solutions of ph=1, ph=7, and ph=13 for 24 h. FIGS.

FIGS. 5D-5E are graphs showing the FTIR transmittance (FIG. 5D) and the X-Ray Diffraction (XRD) (FIG. 5E) spectra of the MF cooling bulk in various environments.

FIG. 5F is a schematic showing the mechanism of the mechanical strength coming from the hydrogen bonds after thermal annealing.

FIG. 5G is a graph showing the stress-strain curve of the annealed MF cooling bulk illustrating its mechanical strength as a potential engineering material for real-world applications.

### DETAILED DESCRIPTION

Cooling buildings consumes tremendous amounts of electricity and results in parasitic greenhouse effects [1-3] to the environments, which exacerbates global warming [4,5] and climate change [6,7]. Therefore, it is crucial to exploit energy-saving and eco-friendly techniques for cooling buildings while minimizing the carbon footprint of environmental sustainability and technical innovations [8]. Radiative cooling refers to a heat transfer mechanism that a hot object contactlessly dissipates its energy to a cold object and thus lowers its temperature via thermal radiation [9]. The outer space, with a temperature of ˜3 K, is an enormous thermal reservoir available to the Earth for the dissipation of redundant heat through the atmospheric transparent window (8-13 μm) in the form of thermal radiation [10-13]. Effective radiative cooling during the nighttime has been substantially investigated and employed for cooling buildings [14-18]. However, passive daytime radiative cooling (PDRC) is more urgent since cooling demands peak during the daytime. To achieve sub-ambient PDRC effects, the designed surface should simultaneously reflect most of the solar irradiance spreading from 0.3 μm to 2.5 μm and radiate excessive heat to the outer space via the atmospheric window [13,19]. Thus, it is of great significance to explore scalable materials that are highly reflective to solar irradiance and have high infrared thermal emittance to achieve a net heat loss under direct sunlight, so that the huge gap between energy depletion and increasing housing affordability can be bridged [20].

Efficient daytime radiative cooling materials based on both organic [21-23] and inorganic [24-26] materials have been widely investigated and employed as PDRC materials over the past few years due to their high solar reflectance and infrared emittance. However, their complex photonic structures limit their large-scale engineering applications as cooling materials [11,13,27]. Organic solution-processed hierarchically porous polymer thin films have been developed to transform the solid poly(vinylidene fluoride)cohexafluoropropylene (PVDF-HFP) into micro-nanoporous films via phase inversion methods to reflect sunlight and radiate mid-infrared energy. These can be easily painted on rooftops and building walls of buildings to achieve a 5° C. sub-ambient cooling effect. Natural bulk wood is delignified into a radiative cooling structural material by employing the backscattering of solar irradiance and the infrared thermal emission of cellulose fibers. It can be straightforwardly applied as structural materials to lower the temperature up to 10° C. However, the flammability of PVDF-HFP porous films and bleached wood and their lack of spectral robustness under harsh environment exposure (acidic or alkaline) emerge as a prominent challenge for building applications [28]. Additionally, the micro-nanopore generation of PVDF-HFP films relies on the evaporation of the organic solvent, which introduces health concerns for construction workers and increases fabrication costs [29]. Hence, the development of fire-resistant and spectrally robust materials that can be easily fabricated remains a big challenge for real-life applications and commercialization.

Melamine-formaldehyde (MF), a thermosetting plastic material, is widely used in flooring and decorative laminates, molding compounds, and adhesives [30-32] due to its excellent thermal, mechanical, and corrosion stability. It can be cured and cross-linked by heating it to over 160° C., becoming sufficiently hard, corrosion-resistant, and fire-resistant without the addition of any curing agent [33,34]. MF microparticles are “ultra-white” which backscatters solar irradiance, making them an excellent reflector. Also, the molecular vibrations of its melamine rings and hydroxyl groups result in a high thermal emittance over the atmospheric window, making it a very good thermal emitter. These excellent thermal, mechanical, and optical properties combined with the ease-to-fabricate approach make it a suitable alternative for an ideal PDRC material. Here, we develop a scalable, fire-resistant, and spectrally robust bulk material capable of efficient daytime radiative cooling via a two-step (hydraulic press and thermal annealing) and bottom-top (microparticles to bulk) synthetic procedure. It has been experimentally demonstrated that the sub-ambient daytime cooling capability of 3.6° C. can be achieved by the MF photonic cooling bulk under direct sunlight of 750 W m−2. The microparticles backscatter the incident solar irradiation to reduce solar heating while the molecular vibrations of the MF polymer chains efficiently dissipate heat away to the cold outer space. Moreover, the MF photonic bulk is proven to be fireproof, spectrally robust, and mechanically tough, which is in contrast with most traditional building materials. Considering its excellent cooling performance and the scalable synthetic process, the MF cooling bulk material paves a way for PDRC materials in industrial engineering applications and emerges as an alternative to moderate the cooling energy demand of buildings.

### Experimental Results

Materials: The MF powders were provided by Qihong Collagen Additives Co., Ltd, China. The basswood and the green laser pen were purchased from Amazon (US). The PS foam was purchased from Home Depot.

Methods: Fabrication of the MF cooling bulk: 20 g MF powders were cold-hydraulic pressed into a rectangular board with a dimension of 8.5 cm×4.0 cm×0.5 cm and then annealed at 170° C. for 1 hour to form the MF cooling bulk.

Materials characterizations: The reflectance spectra (0.3-2.5 μm) were characterized by a Jasco V770 spectrophotometer with a Jasco ISN-923 60 mm integrating sphere with interior coated BaSO₄ based. The incident angle of the light beam was fixed at an angle of 6°. The infrared reflectance spectra (2.5-20 μm) were measured by Jasco FTIR 6600 with a 4 inch PIKE upward gold integrating sphere. The light beam was shined on the sample at an incident angle of 12°. The infrared spectra were normalized by a diffused gold reflectance standard. The reflectance spectra at different AOI were characterized by using wedges of different angles at the sample port of these two integrating spheres.

SEM characterizations: The surface morphologies of samples were characterized by Zeiss Supra 25 SEM under an acceleration voltage of 5 kV.

Size distribution characterizations: The size distributions of MF surfaces were measured by importing the SEM images into ImageJ software and 100 points were randomly measured in each image.

TGA characterizations: The TGA analysis was conducted by the TA instruments Q50 from 25° C. to 900° C. under an airflow flux of 60 ml/min and the heating rate was set to be 10° C.

DSC characterizations: The DSC thermograms were measured by the TA instruments DSC Q200 with a fixed heating rate of 10° C. from 25° C. to 200° C. and the airflow flux was 50 ml/min.

XRD characterizations: The XRD spectra were characterized by the Bruker D8 X-ray Diffractometer scanning from 15° to 100° with a stepsize of 0.02°.

Scattering effect validations: 0.02 g MF particles were uniformly smeared on the 20 μm thick Tape King adhesive tape. The MF particles were placed at the center of the aperture that was between the laser pen and the blackboard. The area of the scattered laser spots was measured to indicate the scattering effects of the MF particles.

Thermal conductivity measurement: The thermal conductivity of samples was characterized by Hotdisk TPS 2500s with an isotropic standard module.

Finite-Difference Time-Domain (FDTD) simulations: FDTD scattering efficiency of the MF particles with a diameter of 8 μm was simulated using the Lumerical FDTD Solution 2020. Two-dimensional models were applied, and a total-field scattered-field source coupled with the scattering cross-sections of MF particles was employed to calculate the scattering efficiency.

Temperature measurements: The temperature of the MF cooling bulk, the wood, and the concrete was monitored by the National Instruments (NI) PXI-6289 board. The K-type thermocouples were fixed to the back of samples using the thermal glue.

Infrared image measurements: Infrared images of samples were taken employing the FLIR A655C thermal camera at a resolution of 640×480 with a 25° lens.

Harsh environment exposure: The MF cooling bulk was immersed into 100 ml solutions of ph=1, ph=7, and ph=13 for 24 h and washed by DI water for 1 minute, then dried by the high-pressure air blowgun.

Mechanical strength measurements: The mechanical strength of the MF cooling bulk (3.0 cm×1.8 cm×0.5 cm) was measured by the Mark-10 ESM tensile tester equipped with a force gauge of 0.5 N resolution.

### Results and Discussion

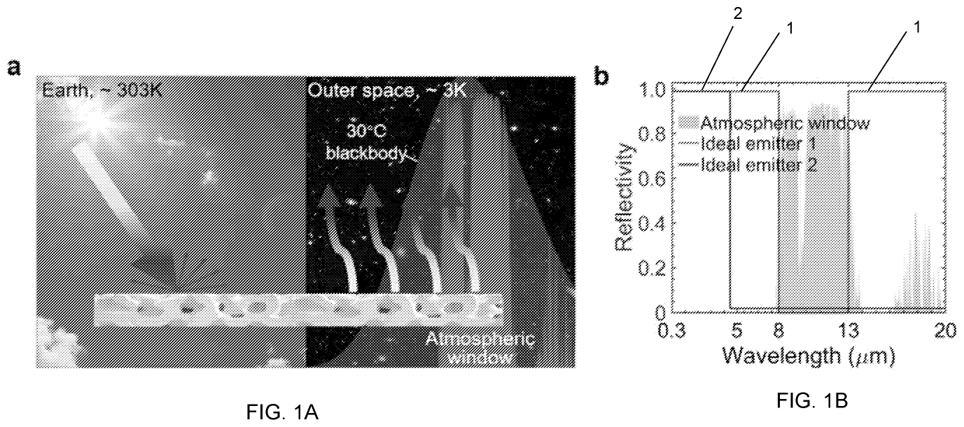

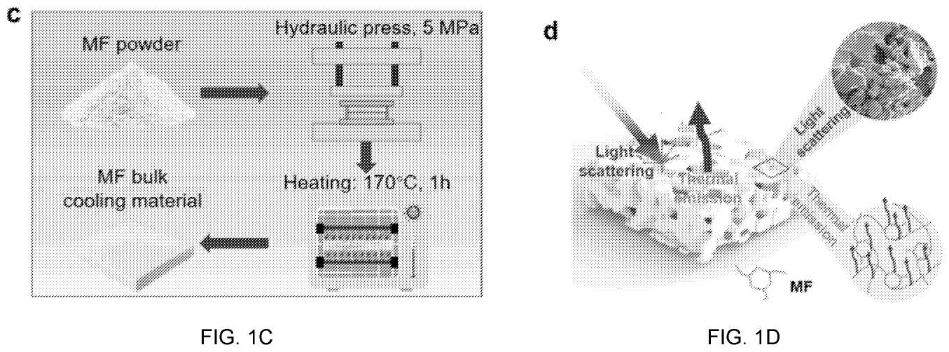

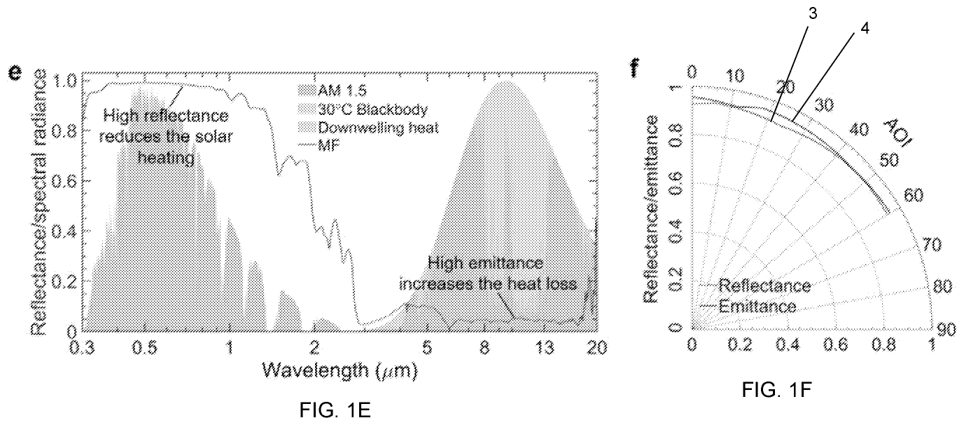

The Earth is warmed via thermal radiation of the Sun, while it cools itself down by radiating heat to the outer space. The atmosphere is highly transparent to thermal infrared radiation from 8 μm to 13 μm, which coincides with the spreading region of a 30° C. blackbody. The main atmospheric window opens a door for objects on Earth to dissipate heat to the cold reservoir and offers opportunities for cooling objects passively without any energy consumption. If an object has a unity solar reflectance to depress solar heating and near-unity thermal emittance over the atmospheric window to improve heat dissipation, it will be cooler than other objects without such spectral selectivity (FIG. 1A). Two different idealized scenarios with spectrally selective reflectance spectrum are shown in FIG. 1B. For scenario 1 (ideal emitter 2, black line), the emittance is unity beyond 4.5 lam and zero otherwise, while for scenario 2 (ideal emitter 1, red line), the emittance is a unity just over the atmospheric transparent window. Ideal emitter 2 is perfect for achieving cooling effects substantially below the ambient temperature, while for ideal emitter 1, the thermal absorption from the ambient partially offsets the radiative cooling power obtained by radiating through the highly transparent atmospheric window. Although the spectral profile of the ideal emitter 1 is the final goal for PDRC material, it is difficult to design and fabricate such photonic structures with feasible methods and abundant materials. The ideal emitter 1 is a promising milestone stone to reach the idealized daytime radiative cooling. Therefore, we design and process a spectrally selective emitter with a similar reflectance profile as ideal emitter 2 using the MF microparticles. MF is originally employed as a wood adhesive and has large annual production levels. MF powders can be processed into stiff solids via a simple bottom-top synthesis by cold hydraulic pressing at 5 MPa and subsequently thermal annealing at 170° C. for 1 h (FIG. 1C) to form a cross-linked MF cooling bulk. The original small MF microparticles merge into larger microparticles and form a diffused and non-absorbing white surface in the solar regions due to light scattering by these microparticles (FIG. 1D). The MF cooling bulk is also strongly emissive, owing to the molecular vibration of its polymer chains (FIG. 1D). It is demonstrated by the measured reflectance spectrum (magenta curve) of the MF cooling bulk as shown in FIG. 1E with an overall solar reflectance of 0.94 and thermal emittance of 0.95. This excellent spectral selectivity ensures its high daytime radiative cooling performance. The incident angle of sunlight varies according to a different time of the day and various seasons or locations. Accordingly, the PDRC materials preferably have a diffused surface with high solar reflectance at a high AOI. Moreover, the high thermal emittance of the PDRC materials for all angles ensures that it can radiate heat to all angles of the sky. FIG. 1F exhibits that the MF cooling bulk possesses high solar reflectance and thermal emittance even at a large AOI (60°). This angle-independent optical profile is attributed to the randomly arranged MF microparticles (FIG. 1D). The rough, porous surface gives rise to a diffused “white” appearance in the solar wavelengths and a diffused “black” appearance in the atmospheric window. Moreover, the diffused surface of the MF cooling bulk reduces the unhealthy visual influence from the specular light reflections on humans eyes, making it suitable for architectural implementations [35].

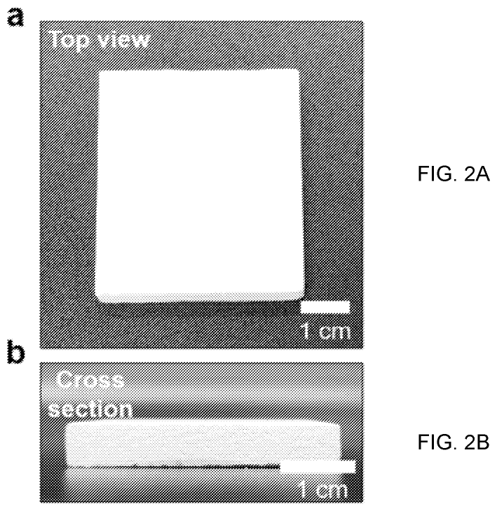

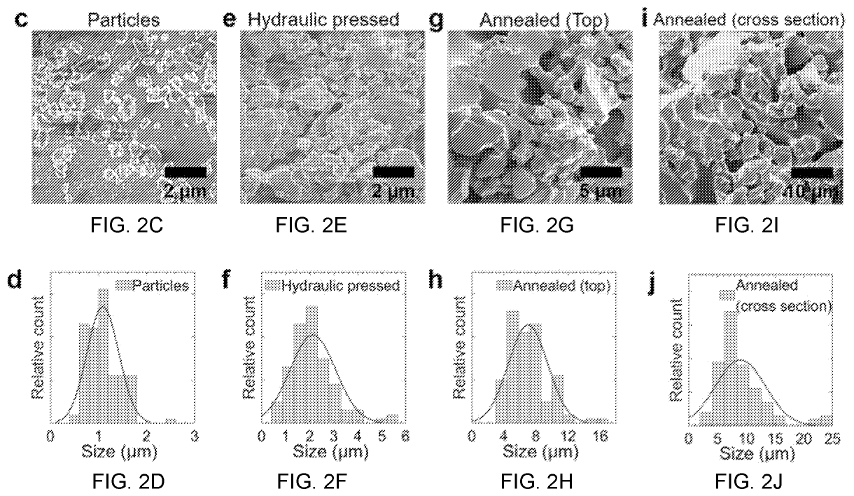

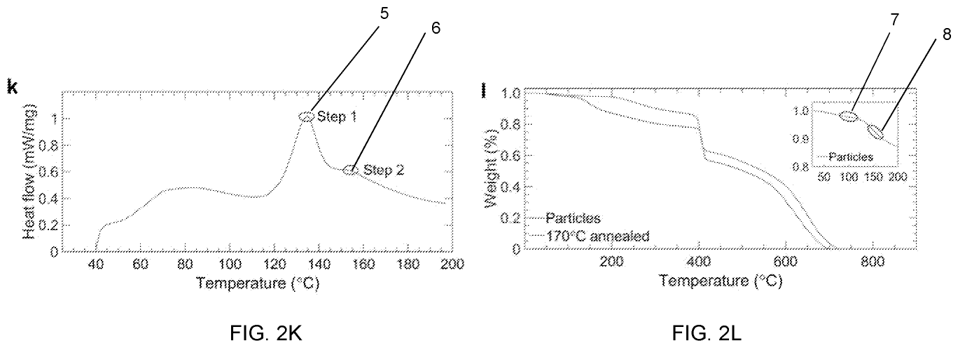

The MF cooling bulk with a super white surface (FIGS. 2A-2B) is engineered by hydraulic pressing the MF microparticles with an average size of 1 μm in diameter (FIGS. 2C-2D) into a bulk material at 5 MPa. The hydraulic pressure forms larger particles with diameters of 2 μm (FIGS. 2E-2F). This transformation of MF particles from fluffy powders into firm solids gives the bulk a moderate mechanical strength necessary for thermal annealing. After being annealed at 170° C. for 1 h, the MF particles merge and cross-link into even larger particles (FIGS. 2G-2J) and possess increased mechanical strength. The annealed MF particles have relatively larger average diameters (˜10 μm) in the cross-section than those of the in-plane particles (˜5 μm), which is explained by the vertical direction of the hydraulic pressure (FIG. 1C). The thermal curing process of the MF is divided into two steps: from 140 to 160° C., the cross-linking reaction is dominated by the reversible demethylolation; When the temperatures goes beyond 160° C., the reaction of methylol to methylene bridges dominates [33]. FIG. 2K shows the DSC thermograms of the MF. The first peak of the exothermal enthalpy circled in red on the left of FIG. 2K indicates the beginning of the cross-linking. After approaching the peak, the enthalpy goes down, meaning the partial completion of the cross-linking reaction. The exothermal enthalpy increases again (the red circle on the right) and then decreases until the cross-linking reaction completes. The DSC thermograms with two exotherms show the two steps of cross-linking reactions. These two processes are also demonstrated by the TGA thermograms of the MF particles (the inset of FIG. 2I). There are two clear weight loss regions (two circles) in the thermograms of the MF particles from 150° C. FIG. 2L shows the TGA thermograms of the MF particles and the annealed MF bulk. The decomposition temperature of the original MF particles and the annealed ones both approach 400° C. The weight loss of the annealed MF bulk is smaller than that of its particles due to the water vaporization and cross-linking reaction when heating the original MF particles.

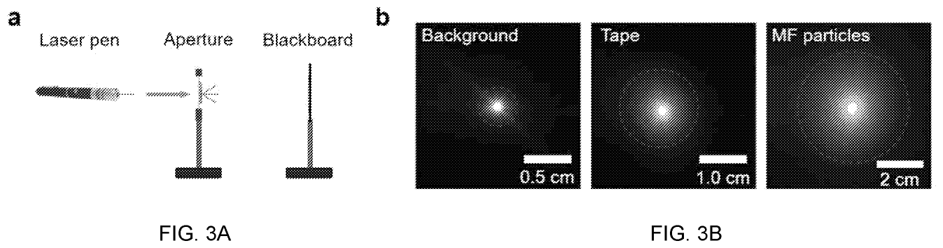

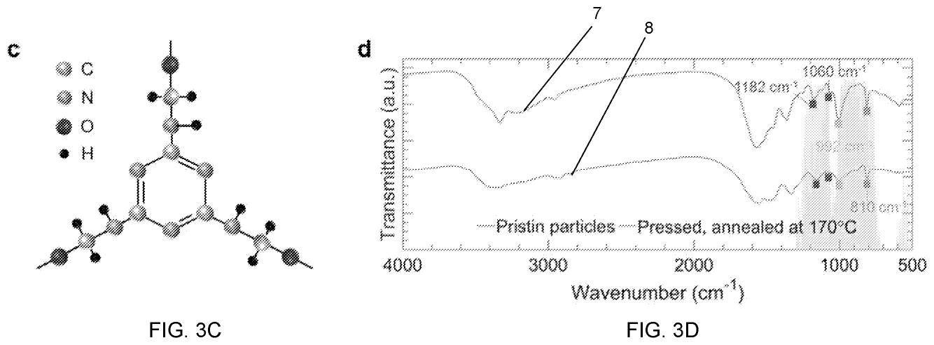

The radiative cooling performance of the MF photonic bulk results from its high solar reflectance and thermal emittance. The solar reflectance arises from its negligible solar absorption and efficient back-scattering of sunlight. The thermal emittance is attributed to the vibrations of chemical bonds in MF. The scattering effects of MF particles are visualized in FIGS. 3A-3B. A green laser (532±10 nm) travels through the MF particles stuck on a clear tape, and the illuminated area shows the scattering effects on the laser beams. The illuminated area of the MF particles is about 4 times that of the clear tape film and 16 times that of the original beam point, which illustrates the strong scattering effects from the MF particles. MF polymer chains consist of melamine rings terminated with hydroxyl groups as shown in FIG. 3C. The Fourier transform infrared (FTIR) transmission spectra show that MF exhibits strong absorption bands from 8-13 μm. The peaks at 1182 cm⁻¹ and 1060 cm⁻¹ are attributed to the stretching vibrations of C—O bond and ether group vibrations, respectively. The absorption peak at 992 cm⁻¹ corresponds to the CH out-of-plane deformations, and the absorption peak at 810 cm⁻¹ results from the bending vibration of the triazine ring (FIG. 3D). These molecular vibrations are contributed to the high thermal emittance of the MF cooling bulk over the atmospheric transparent window.

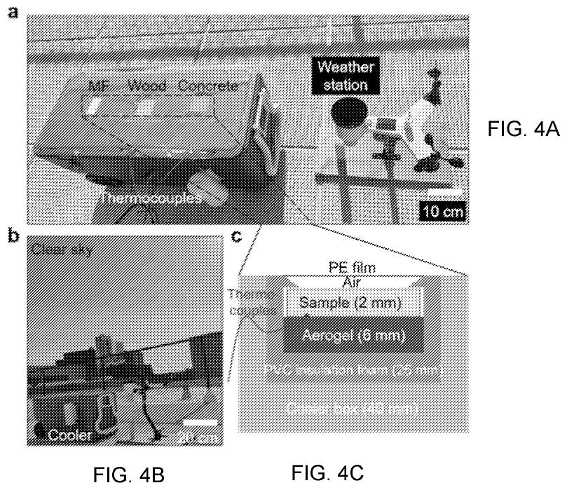

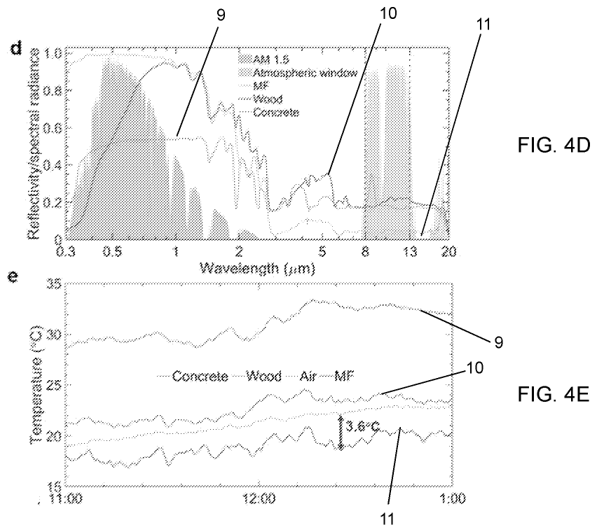

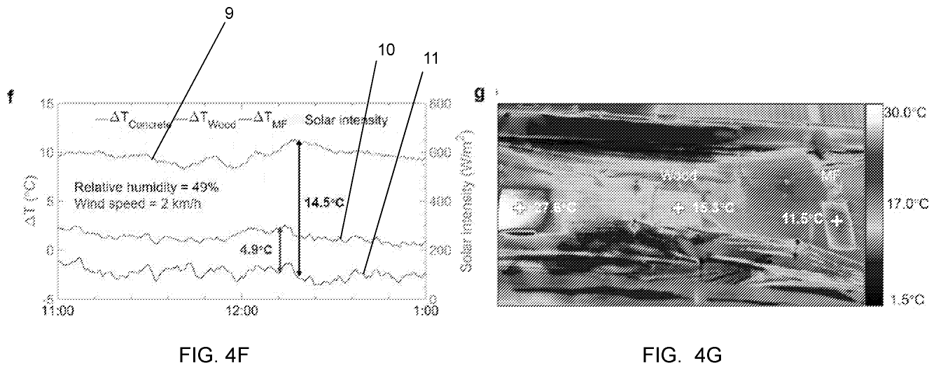

The sub-ambient cooling performance of the MF cooling bulk was characterized on the rooftop from 11:00 AM to 1:00 PM on Oct. 19, 2020 as shown in FIGS. 4A-4B. The MF, wood board, and concrete, all with a thickness of 2 mm, are thermally insulated inside separate chambers, located in a cooler box. The weather station records the solar intensity and the temperatures of these samples are monitored by using K-type thermocouples attached to the back of samples by the National Instruments data acquisition systems. Samples are backed-insulated by a 6 mm aerogel blanket with low thermal conductivity of 23 mW•m⁻¹ •K⁻¹. The thick PVC insulation foam and the cooler walls reduce the parasitic conduction from the ambient (FIG. 4C). These chambers are covered by a 20 μm thick polyethylene (PE) film, which is transparent to solar irradiance and thermal infrared radiation, to undermine the convection from the air, but does not hinder the radiative heat transfer between the samples, the Sun, and the outer space. The reflectance of the MF cooling bulk, wood, and concrete are shown in FIG. 4D. Both the solar reflectance and thermal emittance of the MF bulk are higher than those of the wood and concrete, indicating a better cooling performance of the MF bulk compared with these two common building materials. The recorded temperatures of these three samples and their temperatures difference with the ambient (T sample-T ambient) are shown in FIGS. 4E-4F, respectively. It is shown that both the temperatures of the wood and concrete are higher than the ambient under direct sunlight, while the temperature of MF cooling bulk is below the ambient during the test. The MF cooling bulk maintains a temperature difference that is 2.5° C. below the ambient air despite being exposed directly to the sun irradiance. The maximum temperature difference between the MF cooling bulk and the ambient is 3.6° C. under a solar irradiation of 750 W m⁻². The temperature of the basswood is only 1-2° C. higher than that of the ambient, while the temperature of the concrete is around 14° C. higher. The basswood has a thermal conductivity of 0.11 W m⁻¹ K⁻¹ that is much lower than that of the concrete (0.79 W m⁻¹ K⁻¹). The materials or structures developed for the passive radiative cooling application follow the energy balance: Pₙₑₜ=Pᵣ (T_{Obj})−Ps(T_{Obj}j)−Pₙᵣ (T_{Air}, T_{Obj})−Pₐ(T_{Air}), where Pᵣ stands for the radiative cooling power of the object. P s is the absorbed solar energy power of the object. Pₙᵣ is the non-radiative power between the object and the ambient air. P a represents the incident thermal radiative power from the ambient. Here, T_{Obj} is the temperature of the top surface of materials or structures used in radiative cooling materials. T_{Air} stands for the ambient temperature. According to FIG. 4D, the average thermal emittance of the wood over the transparent window (8-13 μm) is around 0.8, corresponding to an average radiative cooling power (Pr(T_{Obj})−Pa(T_{Air})) of around 124 W m⁻² during the transient state thermal calculation. The calculated overall solar absorptance of the wood is 0.75, and the average solar intensity of the experimental period is around 670 W m⁻². Therefore, the average solar heating power is around 165 W m⁻². The net heating power density on the wood surface equals 41 W m⁻². Here, we neglect the convection heat transfer between the wood and the ambient since we place the PE thin film on top of the chamber as a convection shield on top of the experimental chamber. The calculation of the energy balance shows a temperature increase of 5° C. above the ambient temperature when the top surface of the wood reaches an equilibrium state. This is larger than that of the measured value. The heat conduction between the wood and its surroundings eliminates parts of the temperature increase. In the ideal calculation, these convection and conduction effects are not taken into consideration. Therefore, the measured temperature increase is less than that of the calculated one. The environment temperature sensor is enclosed into a windshield to avoid direct solar irradiation, so the forced convection effect from the wind reduces. That is the reason the fluctuation of the ambient is much smaller than that of the wood, concrete, and MF cooling bulk. The temperature of the MF cooling bulk is on average 3.7° C. and 12.0° C. below the temperature of the wood and concrete samples, respectively, while the maximum temperature differences (T_{wood/concrete}−T_{MF}) are 4.9° C. and 14.5° C., respectively. The surface temperatures of these three samples are monitored using a thermal camera as shown in FIG. 4G (measured on Dec. 7, 2020), which also demonstrates that the surface temperature of the MF cooling bulk is less than that of the wood and concrete.

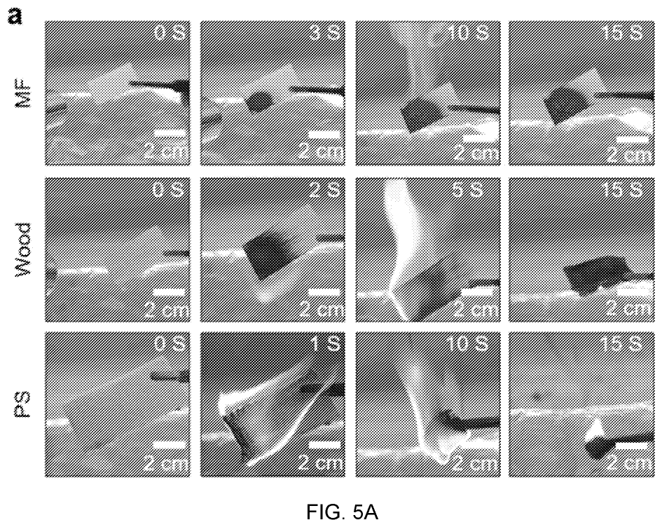

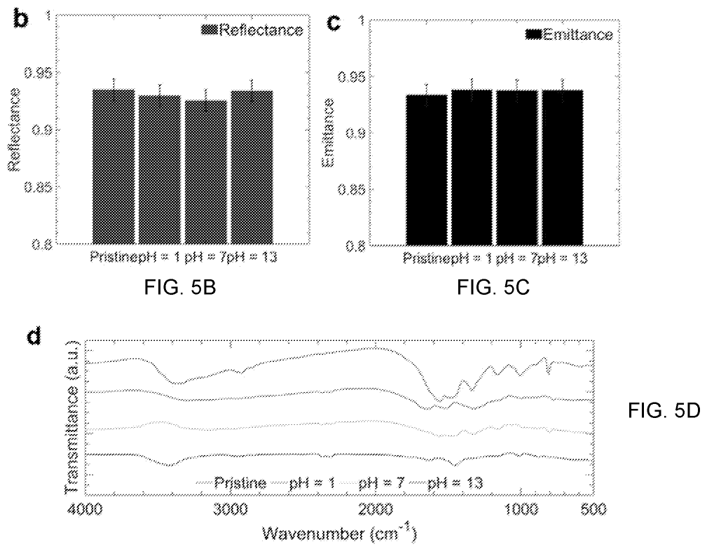

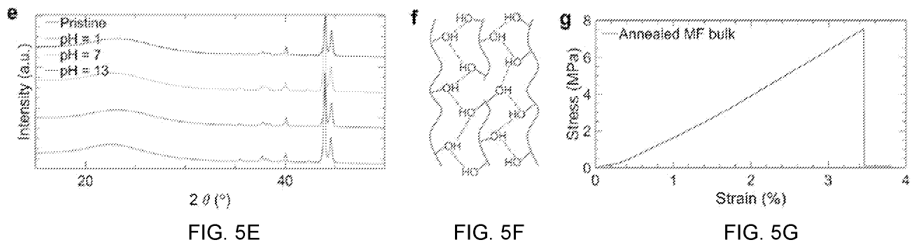

The fire-resistancy of building materials is of great importance to human safety. We test the flammability of MF cooling bulk and compare it with wood and PS, as the latter two are common building materials. The combustion process of these three different materials is recorded after igniting with a blow torch with a flame temperature of ˜1430° C. for 3 seconds (FIG. 5A). The wood and the PS foam are burnt into ashes in 15 seconds while the fame of the MF cooling bulk extinguishes at the 15th second. This validates that the MF cooling bulk is self-extinguishing and safe for use as the building exteriors even though it is a polymer material. The spectral robustness of the PDRC materials is substantial when exposed to harsh environments such as acid or alkali. We examine the spectral robustness of the MF cooling bulk by immersing it in solutions of ph=1, ph=13, and DI water for 24 h and then subsequently measuring their spectra. As shown in FIGS. 5B-5C, the overall solar reflectance and thermal emittance of the MF cooling bulk remain almost identical after these processes, indicating that it is spectrally robust in harsh circumstances and promising for outdoor applications. The FTIR transmittance (FIG. 5D) and XRD (FIG. 5E) spectra of MF cooling bulk confirm that the chemical compositions of MF bulk do not change after elongated exposure to environmental conditions. The mechanical strength of the PDRC is also a key parameter to consider for practical implementations. The MF cooling bulk is also mechanically strong due to the repeated hydrogen-bond formation of hydroxyl groups after hydraulic pressing and cross-linking after annealing (FIGS. 5F-5G), making it very useful for a variety of engineering applications.

### Examples

In one exemplary embodiment, MF photonic cooling bulk is disclosed for covering outer surfaces of a building. The MF photonic cooling bulk comprises a mass of hydraulically pressed MF microparticles that has been thermally annealed to form a fire and corrosion-resistant, cross-linked photonic cooling bulk configured to reflect incident solar irradiation and radiate heat from the building to the outer space.

In one example, the thickness of the MF photonic cooling bulk ranges from 0.5 mm to 4 mm. In one example, the pore sizes of the MF photonic cooling bulk ranges from 2 to 10 um. In one example, the porosity of the MF photonic cooling bulk ranges from 60% to 85%.

In addition to MF, other materials can be used for the photonic cooling bulk. In one example, phenolic plastics with fire-resistant properties can also be processed by the hydraulic pressing and annealing methods described herein.

In summary, we have developed a spectrally robust, cross-linked MF bulk passive radiative cooling material, fabricated by using scalable bottom-top method based on hydraulic-pressing and annealing. Owing to the efficient light-scattering effects of the MF assembly and the strong molecular vibrations of the MF chains, the processed MF bulk material demonstrates a superior sub-ambient cooling effect by simultaneously reflecting sunlight to depress the solar heating and thermally radiating heat to the cold outer space through the atmospheric transparent window. We experimentally and computationally analyze the mechanism for achieving the high solar reflectance and thermal emittance of the MF photonic cooling bulk. The outdoor experiment demonstrates its excellent sub-ambient cooling properties compared to the typical structural materials like wood and concrete. Additionally, this MF bulk shows a more fire-resistant and self-extinguishing capability than that of the wood and PS foam, which is critical for buildings and human safety. Besides, the spectral robustness of the MF bulk after elongated harsh environmental exposure promises lasting high-performance cooling in outdoor applications. This scalable, fire resistant and spectrally robust bulk cooling material provides a promising pathway for extensive green-energy building applications.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions.

Accordingly, the foregoing description and attached drawings are by way of example only, and are not intended to be limiting.

### REFERENCES

[1] U. S. E. Protection, Phaseout of ozone-depleting substances (ODS), 2019, (https://www.epa.gov/ods-phaseout).
[2] B. I. Cook, J. E. Smerdon, R. Seager, S. Coats, Global warming and 21st century drying, Clim. Dyn. 43 (9-10) (2014) 2607-2627.
[3] G.-R. Walther, E. Post, P. Convey, A. Menzel, C. Parmesan, T. J. Beebee, J. M. Fromentin, O. Hoegh-Guldberg, F. Bairlein, Ecological responses to recent climate change, Nature 416 (6879) (2002) 389-395.
[4] G. P. Peters, R. M. Andrew, T. Boden, J. G. Canada, P. Ciais, C. Le Quere, G. Marland, M. R. Raupach, C. Wilson, The challenge to keep global warming below 2C, Nat. Clim. Change 3 (1) (2013) 4-6.
[5] W. R. Turner, M. Oppenheimer, D. S. Wilcove, A force to fight global warming, Nature 462 (7271) (2009) 278-279.
[6] K. Anderson, A. Bows, A new paradigm for climate change, Nat. Clim. Change 2 (9) (2012) 639-640.
[7] W. Thuiller, Climate change and the ecologist, Nature 448 (7153) (2007) 550-552.
[8] M. Santamouris, Cooling the buildings-past, present and future, Energy Build. 128 (2016) 617-638.
[9] Z. M. Zhang, Nano/Microscale Heat Transfer, Springer, 2007.
[10] Y. Tian, L. Qian, X. Liu, A. Ghanekar, G. Xiao, Y. Zheng, Highly effective photon-to-cooling thermal device, Sci. Rep. 9 (1) (2019) 1-11.
[11] T. Li, Y. Zhai, S. He, W. Gan, Z. Wei, M. Heidarinejad, D. Dalgo, R. Mi, X. Zhao, J. Song, et al., A radiative cooling structural material, Science 364 (6442) (2019) 760-763.
[12] A. P. Raman, M. Abou Anoma, L. Zhu, E. Rephaeli, S. Fan, Passive radiative cooling below ambient air temperature under direct sunlight, Nature 515 (7528) (2014) 540-544.
[13] Y. Zhai, Y. Ma, S. N. David, D. Zhao, R. Lou, G. Tan, R. Yang, X. Yin, Scalable-manufactured randomized glass-polymer hybrid metamaterial for daytime radiative cooling, Science 355 (6329) (2017) 1062-1066.
[14] A. Gentle, J. Aguilar, G. Smith, Optimized cool roofs: integrating albedo and thermal emittance with r-value, Sol. Energy Mater. Sol. Cells 95 (12) (2011) 3207-3215.
[15] D. Michell, K. Biggs, Radiation cooling of buildings at night, Appl. Energy 5 (4) (1979) 263-275.
[16] T. M. Nilsson, G. A. Niklasson, Radiative cooling during the day: simulations and experiments on pigmented polyethylene cover foils, Sol. Energy Mater. Sol. Cells 37 (1) (1995) 93-118.
[17] T. M. Nilsson, G. A. Niklasson, C. G. Granqvist, Solar-reflecting material for radiative cooling applications: ZnS pigmented polyethylene, in: Optical Materials Technology for Energy Efficiency and Solar Energy Conversion XI: Selective Materials, Concentrators and Reflectors, Transparent Insulation and Superwindows, 1727, International Society for Optics and Photonics, 1992, pp. 249-262.
[18] S. Catalanotti, V. Cuomo, G. Piro, D. Ruggi, V. Silvestrini, G. Troise, The radiative cooling of selective surfaces, Sol. Energy 17 (2) (1975) 83-89.
[19] X. Liu, Y. Tian, F. Chen, A. Ghanekar, M. Antezza, Y. Zheng, Continuously variable emission for mechanical deformation induced radiative cooling, Commun. Mater. 1 (1) (2020) 1-7.
[20] T. Abbasi, S. Abbasi, Renewable Energy Sources: Their Impact on Global Warming and Pollution, PHI Learning Pvt. Ltd., 2011.
[<] J. Mandal, M. Jia, A. Overvig, Y. Fu, E. Che, N. Yu, Y. Yang, Porous polymers with switchable optical transmittance for optical and thermal regulation, Joule 3 (12) (2019) 3088-3099.
[22] P. C. Hsu, A. Y. Song, P. B. Catrysse, C. Liu, Y. Peng, J. Xie, S. Fan, Y. Cui, Radiative human body cooling by nanoporous polyethylene textile, Science 353 (6303) (2016) 1019-1023.
[23] Y. Chen, J. Mandal, W. Li, A. Smith-Washington, C.-C. Tsai, W. Huang, S. Shrestha, N. Yu, R. P. Han, A. Cao, et al., Colored and paintable bilayer coatings with high solar-infrared reflectance for efficient cooling, Sci. Adv. 6 (17) (2020) eaaz5413.
[24] J. Mandal, S. Du, M. Dontigny, K. Zaghib, N. Yu, Y. Yang, Li4 Ti5 O12: a visible-to-infrared broadband electrochromic material for optical and thermal management, Adv. Funct. Mater. 28 (36) (2018) 1802180.
[25] H. Zhao, Q. Sun, J. Zhou, X. Deng, J. Cui, Switchable cavitation: switchable cavitation in silicone coatings for energy-saving cooling and heating (adv. mater. 29/2020), Adv. Mater. 32 (29) (2020) 2070215.
[26] E. Rephaeli, A. Raman, S. Fan, Ultrabroadband photonic structures to achieve high-performance daytime radiative cooling, Nano Lett. 13 (4) (2013) 1457-1461.
[27] J. Mandal, Y. Fu, A. C. Overvig, M. Jia, K. Sun, N. N. Shi, H. Zhou, X. Xiao, N. Yu, Y. Yang, Hierarchically porous polymer coatings for highly efficient passive daytime radiative cooling, Science 362 (6412) (2018) 315-319.
[28] L. A. Lowden, T. R. Hull, Flammability behavior of wood and a review of the methods for its reduction, Fire Sci. Rev. 2 (1) (2013) 4.
[29] G. Malaguarnera, E. Cataudella, M. Giordano, G. Nunnari, G. Chisari, M. Malaguarnera, Toxic hepatitis in occupational exposure to solvents, World J. Gastroenterol. WJG 18 (22) (2012) 2756.
[30] B. D. Park, H.-W. Jeong, Cure kinetics of melamine—formaldehyde resin/clay/cellulose nanocomposites, J. Ind. Eng. Chem. 16 (3) (2010) 375-379.
[31] D. K. Raval, A. J. Patel, B. N. Narola, A study on composites from casein modified melamine-formaldehyde resin, Polym. Plast. Technol. Eng. 45 (3) (2006) 293-299.
[32] A. Kumar, V. Katiyar, Modeling and experimental investigation of melamine-formaldehyde polymerization, Macromolecules 23 (16) (1990) 3729-3736.
[33] D. J. Merline, S. Vukusic, A. A. Abdala, Melamine formaldehyde: curing studies and reaction mechanism, Polym. J. 45 (4) (2013) 413-419.
[34] D. Wang, X. Zhang, S. Luo, S. Li, et al., Preparation and property analysis of melamine formaldehyde foam, Adv. Mater. Phys. Chem. 2 (4) (2012) 63-67.
[35] S. F. Chichibu, K. Kojima, A. Uedono, Y. Sato, Defect-resistant radiative performance of m-plane immiscible all-xinxn epitaxial nanostructures for deep-ultraviolet and visible polarized light emitters, Adv. Mater. 29 (5) (2017) 1603644.

1. A method, comprising the steps of:
(a) hydraulically pressing Melamine Formaldehyde (MF) microparticles; and
(b) thermally annealing the pressed MF microparticles to form a fire-resistant, corrosion-resistant, cross-linked MF photonic cooling bulk configured for covering outer surfaces of a building to reflect incident solar irradiation on the building and radiate heat from the building to the outer space.

2. The method of claim 1, wherein the pressed MF microparticles are thermally annealed by heating the pressed MF microparticles to a temperature above 160° C.

3. The method of claim 1, wherein the pressed MF microparticles are thermally annealed without addition of a curing agent.

4. The method of claim 1, wherein the MF photonic cooling bulk has a thickness of 0.5 mm to 4 mm.

5. The method of claim 1, wherein the MF photonic cooling bulk has a pore size of 2 μm to 10 μm.

6. The method of claim 1, wherein the MF photonic cooling bulk has a porosity of 60% to 85%.

7. The method of claim 1, wherein the MF photonic cooling bulk backscatters the incident solar irradiation to reduce solar heating of the building, and wherein molecular vibrations of MF polymer chains in the MF photonic cooling bulk dissipate heat away from the building to the outer space.

8. The method of claim 1, wherein the MF photonic cooling bulk is self-extinguishing.

9. The method of claim 1, further comprising the step of securing the MF photonic cooling bulk on outer surfaces of the building.

10. The method of claim 1, wherein the MF microparticles are hydraulically pressed at a pressure of about 5 MPa, and the pressed MF microparticles are annealed at a temperature of about 170° C. for about one hour.

11. Melamine Formaldehyde (MF) photonic cooling bulk for covering outer surfaces of a building comprising a mass of hydraulically pressed MF microparticles that has been thermally annealed to form a fire-resistant, corrosion-resistant, cross-linked photonic cooling bulk configured to reflect incident solar irradiation and radiate heat from the building to the outer space.

12. The MF photonic cooling bulk of claim 11, wherein the MF microparticles backscatter the incident solar irradiation to reduce solar heating of the building, and wherein molecular vibrations of MF polymer chains dissipate heat away from the building to the outer space.

13. The MF photonic cooling bulk of claim 11, wherein the mass of hydraulically pressed MF microparticles is annealed by heating it to a temperature above 160° C.

14. The MF photonic cooling bulk of claim 13, wherein the mass of hydraulically pressed MF microparticles is annealed without addition of a curing agent.

15. The MF photonic cooling bulk of claim 11, wherein the MF photonic cooling bulk is self-extinguishing.

16. The MF photonic cooling bulk of claim 11, wherein the MF photonic cooling bulk is corrosion-resistant from exposure to acidic and alkaline solutions.

17. The MF photonic cooling bulk of claim 11, wherein the MF photonic cooling bulk has a thickness of 0.5 mm to 4 mm.

18. The MF photonic cooling bulk of claim 11, wherein the MF photonic cooling bulk has a pore size of 2 μm to 10 μm.

19. The MF photonic cooling bulk of claim 11, wherein the MF photonic cooling bulk has a porosity of 60% to 85%.

20. Phenolic plastic photonic cooling bulk for covering outer surfaces of a building comprising a mass of hydraulically pressed phenolic plastic microparticles that has been thermally annealed to form a fire-resistant, corrosion-resistant, cross-linked photonic cooling bulk configured to reflect incident solar irradiation and radiate heat from the building to the outer space.
